(19) United States
(12) Patent Application Publication
(10) Pub. No.: US 2022/0383251 A1
(43) Pub. Date: Dec. 1, 2022

(54) AUGMENTED REALITY TRANSPORT UNIT POD DIVERSION

(71) Applicant: AT&T Intellectual Property I, L.P., Atlanta, GA (US)

(72) Inventors: Robert T. Moton, JR., Alpharetta, GA (US); Adrianne Binh Luu, Atlanta, GA (US); James Pratt, Round Rock, TX (US); Barrett Kreiner, Woodstock, GA (US); Walter Cooper Chastain, Atlanta, GA (US); Ari Craine, Marietta, GA (US); Robert Koch, Peachtree Corners, GA (US)

(21) Appl. No.: 17/330,730

(22) Filed: May 26, 2021

(51) Int. Cl. G06Q 10/08; G06T 11/00; H04W 4/029; G08B 5/22; G06K 7/10

(52) U.S. Cl. CPC G06Q 10/0833; G06T 11/001; H04W 4/029; G08B 5/22; G06K 7/10366

(57) ABSTRACT

A processing system may track a location of a user on a journey in connection with an associated group of transport units having commenced a shipment from a same origin to a same destination in a shipping network, detect at least one change related to the journey comprising at least one of: that the location of the user deviates from an expected location or that a user itinerary has changed, and divert the group of transport units in the shipping network, in response to the detecting the at least one change, the diverting comprising transmitting at least one instruction to cause at least one visual display characteristic to be presented when one or more of the transport units are viewed via an augmented reality endpoint device, the at least one visual display characteristic distinguishing the group of transport units from other transport units that are not in the group.

The present disclosure relates generally to parcel handling systems and shipping networks, and more particularly to methods, computer-readable media, and apparatuses for diverting a group of transport units in a shipping network, via at least one instruction to cause at least one visual display characteristic to be presented when transport units of the group are viewed via an augmented reality endpoint device, in response to detecting at least one change related to a journey of a user associated with the group of transport units.

### BACKGROUND

Current trends in wireless technology are leading towards a future where virtually any object can be network enabled and Internet Protocol (IP) addressable. The pervasive presence of wireless networks, including cellular, Wi-Fi, ZigBee, satellite and Bluetooth networks, and the migration to a 128-bit IPv6-based address space provides the tools and resources for the paradigm of the Internet of Things (IoT) to become a reality. In addition, “smart luggage” is increasingly becoming prevalent. So called “smart luggage” may provide battery power to charge and run mobile computing devices, and may include opening detection and local proximity sensing.

### SUMMARY

In one example, the present disclosure describes a method, computer-readable medium, and apparatus for diverting a group of transport units in a shipping network, via at least one instruction to cause at least one visual display characteristic to be presented when transport units of the group are viewed via an augmented reality endpoint device, in response to detecting at least one change related to a journey of a user associated with the group of transport units. For instance, in one example, a processing system including at least one processor may track a location of a user who is on a journey in connection with an associated group of transport units that have commenced a shipment as a group from a same origin to a same destination in a shipping network and detect at least one change related to the journey, the at least one change comprising at least one of: that the location of the user deviates from an expected location or that an itinerary of the user for the journey has changed. The processing system may then divert the group of transport units in the shipping network, in response to detecting the at least one change related to the journey, where the diverting comprises transmitting at least one instruction to cause at least one visual display characteristic to be presented when one or more transport units of the group of transport units are viewed via an augmented reality endpoint device, and where the at least one visual display characteristic distinguishes the group of transport units from other transport units that are not in the group of transport units.

### BRIEF DESCRIPTION OF THE DRAWINGS

The teaching of the present disclosure can be readily understood by considering the following detailed description in conjunction with the accompanying drawings, in which:

FIG. 1 illustrates an example system related to the present disclosure;

FIG. 2 illustrates an example display view of an augmented reality endpoint device, in accordance with the present disclosure;

FIG. 3 illustrates a flowchart of an example method for diverting a group of transport units in a shipping network, via at least one instruction to cause at least one visual display characteristic to be presented when transport units of the group are viewed via an augmented reality endpoint device, in response to detecting at least one change related to a journey of a user associated with the group of transport units; and

FIG. 4 illustrates an example high-level block diagram of a computing device specifically programmed to perform the steps, functions, blocks, and/or operations described herein.

To facilitate understanding, identical reference numerals have been used, where possible, to designate identical elements that are common to the figures.

### DETAILED DESCRIPTION

Examples of the present disclosure describe methods, computer-readable media, and apparatuses for diverting a group of transport units in a shipping network, via at least one instruction to cause at least one visual display characteristic to be presented when transport units of the group are viewed via an augmented reality endpoint device, in response to detecting at least one change related to a journey of a user associated with the group of transport units. In particular, examples of the present disclosure include electronic identification tags for a group of transport units for transportation along a route associated with a user who is also engaging in transportation along the route. The electronic identification tags may each contain a set of static and dynamic data and network communications capabilities that enable a number of useful functions. In one example, the electronic identification tags may communicate with each other and with other people or other items, such as a mobile computing device of the user, checkpoints, transport vehicles such as planes, trucks, and/or shipping containers, and so forth. In accordance with the present disclosure, the electronic identification tags may also interact with virtual reality endpoint devices of operators within a shipping network (e.g., carrier personnel), as described in greater detail herein. The user and the transport units traverse a route, but their paths and their arrival times at the destination may differ. The transport carriers may differ as well.

To illustrate, a user may use an Internet browser or a wireless app to make travel arrangements from point A to point B. The user may use one or more travel methods and service providers to make the trip along a route. For instance, the user may use a ride sharing service to get to an airport, then take a flight, then use a shuttle service to reach a rental car facility, then use a rental car to drive to a hotel. The user may have a set of luggage, boxes, crates, bins, or other parcels (broadly “transport units”) that the user wishes to send to the destination separate from the user, so as not to have to keep up with the transport units along the way. When establishing a leg of the trip, such as the flight, the user may be offered to have their luggage be shipped via a different route to the destination. This offer may come from the airline, or an alternate carrier, or multiple offers may be presented.

In an example in connection with airline travel, when the user indicates a desire to pre-ship a set of transport units (e.g., luggage items), the airline app may scan electronic luggage tags (e.g., “electronic identification tags”), such as via a bar code or other near-field communication mechanisms to collect data about the transport units from data stored on the respective electronic identification tags (e.g., in a tag information record contained on each of the electronic identification tags). For instance, a tag information record may store data about the associated transportation unit, such as user identifying data, transportation unit type, dimensions, color, features, a unique transportation unit identifier, and so forth. One or more of the transport units may include a handle weight sensor, to record and/or keep track of the weight of the transport units (which may change over time and in the course of a journey) in the respective tag information record.

The airline app may send data such as the pickup location, the destination, the date and time of pickup, the date and time of expected arrival at the destination, and data from the tag information record, such as transport unit dimensions and weight, to one or more shipping providers (e.g., carriers). The carriers may determine whether to offer shipping services and at what price, and the offers may be sent to the user. Each carrier may present one or more offers for shipping based on arrival time and specific delivery point. For instance, offers may vary based on whether the transport units are delivered to the user at the airport, in the trunk of a rental car, to a hotel, etc. The carriers may make their offers based on their other planned logistics traffic in the area at the time, the dimensions and weight of the transport units, the user's status as a customer (e.g., a rewards member, or the like), and other factors.

The user may select a pre-shipping option and the choice may be communicated to the selected carrier(s). If the user selected for the transport units to be delivered to a destination requiring coordination with another provider, the user's app may communicate with servers for those providers to coordinate the delivery. For instance, if Carrier A is selected as the shipping carrier, the user's airline app may communicate with user apps for Rental Car Service 1 and/or Hotel 1 to provide data describing the trip and the plans for shipping of the set of transport units via Carrier A. The data may include the unique identifiers for the electronic identification tags of the transport units and a unique identifier for the user. Rental Car Service 1 and/or Hotel 1 can then use this data in the coordination of the delivery of the transport units. For instance, if the user specified to pick up the transport units at the rental car facility, when it arrives there, then Rental Car Service 1 can associate the transport units with the user and the selected rental car, and place the transport units in the car before the user arrives. Likewise, the transport units may be placed in the user's hotel room before the user arrives.

In another example, there may exist a virtual assistant (VA) app or a travel manager app on the user's endpoint device. This app may provide all coordination of this flow of data among the servers and databases involved for various entities. For instance, a VA app may be responsive to voice inputs from the user. The user may speak a command such as “Book me a trip from home to the Hotel 1 in San Francisco with a rental car from Rental Car Service 1 and have my luggage items pre-shipped to the hotel room.” The VA app may parse the speech input to convert the command into sub-commands for booking each of the legs of the trip for the user's journey. The VA may also access data about the transport units, create the shipping options, and make the required arrangements for the delivery with one or more carriers.

As the transport units traverse a journey, one or more of the electronic identification tags may send updates to the user of the location(s). The updates may be autonomously sent to the user by the electronic identification tags, all or a portion of which may have location awareness via, for instance a GPS receiver. All or a portion of the tags may also have network communication capabilities, such as Wi-Fi and wide area networks such as the Internet. Alternatively, the user may query the electronic identification tags for location(s) via an app and the transport unit(s)′ unique identifier(s), such as IP addresses. The query may also be sent to the shipping carrier to provide additional information such as estimated time of arrival. The virtual assistant app may also be used to create a query.

In one example, at a point in the journey, the user may have a change in travel plans. For instance, the user may change hotels, change rooms at the same hotel, or decide to have the transport units delivered to the rental car rather than to the hotel room. The user may specifically change the travel itinerary, or the airline may change the itinerary, e.g., canceling a flight and automatically rebooking the user for the same flight the next day (which may also automatically change the rental car and/or hotel arrangement). Alternatively, or in addition, the user may spontaneously change travel plans or may have an unintended delay or detour, which may be detected in various ways, such as determining that the user is not at an expected location during the course of the journey, e.g., the user has not arrived at the destination airport when expected (e.g., the user was not on the flight or the flight was delayed or detoured to another airport), or within a period of time after expected to be at the destination, the flight the user was scheduled to be on has already departed, but the user and/or the user's mobile device is tracked to be at home, still at the departure airport, etc.

In one example, the change may be detected by the user's mobile device and sent from the user's app or virtual assistant to the shipping carrier and the old and new destinations. In another example, the change may be determined by a carrier or other service providers associated with the movement of the user (e.g., the passenger airline determining a change in the flight schedule, a change in destination airport, etc.) and communicated to one or more carriers responsible for the transport of the set of luggage items. The carrier(s) handling the set of transport units may then divert the transport units towards a new destination that is determined. Alternatively, or in addition, in one example, the transport units may be sent to a temporary storage facility, or held at a current location or a next available location within the shipping network (e.g., at a hub facility of a carrier). For instance, if the user's specific rental car has not been determined, the preference may be for the transport units to be delivered to a storage locker at the rental car facility that the user may access via a code that is sent to the user's device, such as an electronic key code sent to the car rental app on the user's device. Thus, a virtual assistant app, the airline, the hotel, the car rental agency, or any combination of such entities may detect a change in the user's travel plans/itinerary, or an event or circumstance that may lead to a change in the actual travel of the user. Similarly, the transit of the set of transport units may be delayed after the user is in transit, which may be detected by the carrier(s) handling the luggage items through their delivery management system(s) and communicated to the user and/or to carriers or other entities associated with the transit of the user on the journey. In one example, a virtual assistant app may recommend to the user to switch the destination of the set of transport units based upon the delay or other change in the transit of the transport units. For instance, if it is anticipated that the transport units likely cannot be delivered and placed in the trunk of the rental car before the user arrives, it may be recommended to have the transport units diverted to the hotel rather than to the rental car. Accordingly, in one example, the user may accept or decline the recommendation, and may alternatively request a different option, such as diverting the transport units to a storage facility, etc.

In one example, the electronic identification tags of one or more of the transport units may include a display screen, which may be used to display a bar code or other information that may be used for identification or other purposes. The electronic identification tag may also include a tag database which may store data that may be used for various purposes and functions. The electronic identification tag (e.g., active or passive RFID tags) may also include components for communication via one or more modalities, which may include near-field communication (NFC), and wide area network (WAN) communication, such as cellular or non-cellular wireless communications. Thus, the electronic identification tags may use communication capabilities to access a wide area network via Wi-Fi, Long Term Evolution (LTE), 5E, or others, to create or update an entry in a network-based transport unit management database, which may contain tag data for a multiplicity of electronic identification tags for various users. The electronic identification tags may be implemented as fixed parts of the transport units, or as separate items that may be affixed to or contained within the transport units. The electronic identification tags may be on the exterior of the transport units or may be within the transport units when closed, e.g., to provide better durability and security.

The electronic identification tags may each contain a unique identifier that may be used to address communications with the electronic identification tag and which may be used as an index to store or retrieve tag data associated with the electronic identification tag in the transport unit management database. This may be an Internet Protocol (IP) address or similar identifier. This data may also be sent to and maintained within the transport unit management database, e.g., during a registration process.

Over time, the electronic identification tags may detect and update changes to some types of data in the on-board tag information records. Each electronic identification tag may also be in communication with any of the previously noted types of sensors that are also on-board the luggage item via network or NFC capabilities used by the sensors (e.g., including wireless and/or wired communication). The electronic identification tags may also create time-stamped logs to track data changes over time. In this manner, the electronic identification tags may record the time duration of a journey, the location of the electronic identification tags (and hence the location of the transport units) at points in time, and so forth. One or more of the electronic identification tags may also be in communication with a mobile computing device of the user (e.g., a transport unit management app thereon) to allow tracking of the location of the electronic identification tags.

An electronic identification tag may be in communication with other electronic identification tags that it is associated with, for instance, all transport units of a family traveling together (or multiple transport units of a single user). In this case the transport units and their associated electronic identification tags may be set up as members of a pod. All electronic identification tags within a pod may have the same unique pod ID, which may be established using the wireless app when the user (e.g., one of the family members) is packing for the trip. One of the electronic identification tags may be designated as a pod leader tag during the setup. The pod leader tag may query the other electronic identification tags and track, manage, and report status of the pod as a whole. The pod leader tag may ensure that the pod stays together in proximity and may send an alert, or alerts if any members of the pod stray away. If other electronic identification tags within the pod detect an absence or unexpected location of the pod leader tag, the remaining members of the pod may note that the pod leader tag is away and elect a new pod leader tag. This “election” may be based on factors such as each transport unit's and/or each electronic identification tag's travel history or owner. For instance, in the case of a family of two parents and a child traveling together, if one parent's bag is lost, the other parent's bag can take over. In another example, a transport unit with the greatest capabilities (e.g., based upon highest CPU speed, most memory, largest capacity battery, greatest wireless communication range, etc., or any combination thereof) may be selected as the new pod leader tag, and so forth. In this regard, it should be noted that in one example, some of the electronic identification tags may comprise radio frequency identification (RFID) tags, e.g., passive tags, which may not have independent WAN or other wireless communication capabilities, e.g., Wi-Fi, NFC, etc. However, these tags may still be tracked locally by a pod leader tag (or multiple other electronic identification tags) with additional capabilities (e.g., greater power or signaling capabilities) that can communicate with such passive tags.

The electronic identification tags may also interact with other elements of the environment, which may be in the context of various legs of a journey, such as RFID tags/beacons that may be sensed and recorded on the electronic identification tags. For instance, the electronic identification tags may communicate with and/or be detected/sensed by automated baggage handling systems, or carriers' shipment sorting systems to facilitate proper transshipment (e.g., receiving at a sorting/transshipment facility and loading the transport units onto the proper truck, train, aircraft, etc. for transport on a next leg of a journey).

In a similar manner, the electronic identification tags may be used to store data related to a service-level agreement (SLA) that the user either has established through prior arrangement or payment with a carrier or may be used to negotiate an SLA with a carrier on-the-spot. For instance, the transport units may contain fragile contents and require delicate handling. The user may accordingly designate an SLA with a carrier, for instance a ground shipping carrier, to indicate that delicate handling should be applied to the transport units. The electronic identification tags may broadcast this SLA to any equipment or personnel of the carrier along the travel path via near-field or other communication means so that appropriate handling may be applied. For example, a baggage handler may wear augmented reality (AR) glasses and see an AR “FRAGILE” display, or the electronic identification tags may comprise or be in communication with a display screen of the transport units to present the same or similar information.

In addition, as noted above, carrier(s) handling the set of transport units may divert the transport units towards a new/alternate destination when a change in travel plans of the user is detected (e.g., a change in the user's travel itinerary) or when the user experiences an unintended delay or detour, or is otherwise not at an expected location during the course of the journey. In one example, the diverting may be accomplished by updating the carrier's automated baggage handling systems (or parcel sorting systems), or records/data utilized by such system(s) to automatically route transport units or other parcels in a shipping network. For instance, the user's mobile device and/or an airline or other carrier that is transporting the user may detect the change or other conditions and may notify the carrier(s) handling the transport of the transport units, which may cause the diversion of the transport units. In one example, the transport units may be held at a next available location where the movement of the transport units may be stopped, such as at a transport hub and/or a sorting/transshipment facility of a carrier e.g., until a different final destination is determined. In another example, an alternate final destination may be determined before reaching a next transshipment point in the shipping network. Therefore, at the next transshipment point, the transport units may be properly routed/handled, e.g., to divert the transport units towards the new final destination.

In one example, a scan of the electronic identification tag by automated baggage handling systems or carriers' parcel sorting systems may identify the transport units and thus indicate the new destination (when such new destination is pre-populated into the system). Alternatively, or in addition, in one example, the present disclosure may provide at least one instruction to cause at least one visual display characteristic to be presented when one or more of the transport units are viewed via an AR endpoint device (e.g., of personnel of one or more carriers transporting the transport units), wherein the at least one visual display characteristic distinguishes the set of transport units from other items in the shipping network that are not in the set of transport units. For instance, in one example, the at least one instruction comprises altering a value in a server record relating to the set of transport units. Thus, when the electronic identification tag(s) is/are scanned/detected by the AR device, the value may be retrieved by the augmented reality endpoint device from the server record, which may the cause the AR device to present the visual display characteristic. For example, the visual display characteristic may comprise a highlighting being overlaid on the one or more of the transport units, to distinguish the set of transport units from other transport units in the shipping network that may also be visible via the AR device, e.g., a same color highlighting. Thus, carrier personnel may be given a strong visual indication that these transport units should not be separated and should be diverted as a group. In one example, the at least one visual display characteristic may further comprise a display of an alternate destination for the set of transport units, e.g., an explicit indication of where the set of transport units should be sent, and/or other information, such as an indication of a total number of items in the group, and so forth.

In one example, an instruction may be provided to the electronic identification tags regarding the alternate destination (e.g., a hold at a current location or next available location where a hold is possible, or an alternate final destination). In such case, the electronic identification tag(s) may provide the visual display characteristic to the AR device, e.g., when scanned by the AR device. For instance, the electronic identification tag(s) may be independently notified that diversion of the set of transport units should be effected, e.g., via a WAN communication, such as over a cellular network. In this case, the transport units may provide an indication of the carrier personnel via one or more AR devices, even before the carrier's systems can be updated via another channel. For example, the user may also be notified or become aware of a travel issue, but may not immediately determine an alternate final destination. For instance, the user may be on-board a flight and may not have Internet access for several hours. Thus, the user may eventually determine an alternate final destination and notify the carrier accordingly. In the meantime, a hold on the transport units may be separately effected via direct communication to the electronic identification tag(s).

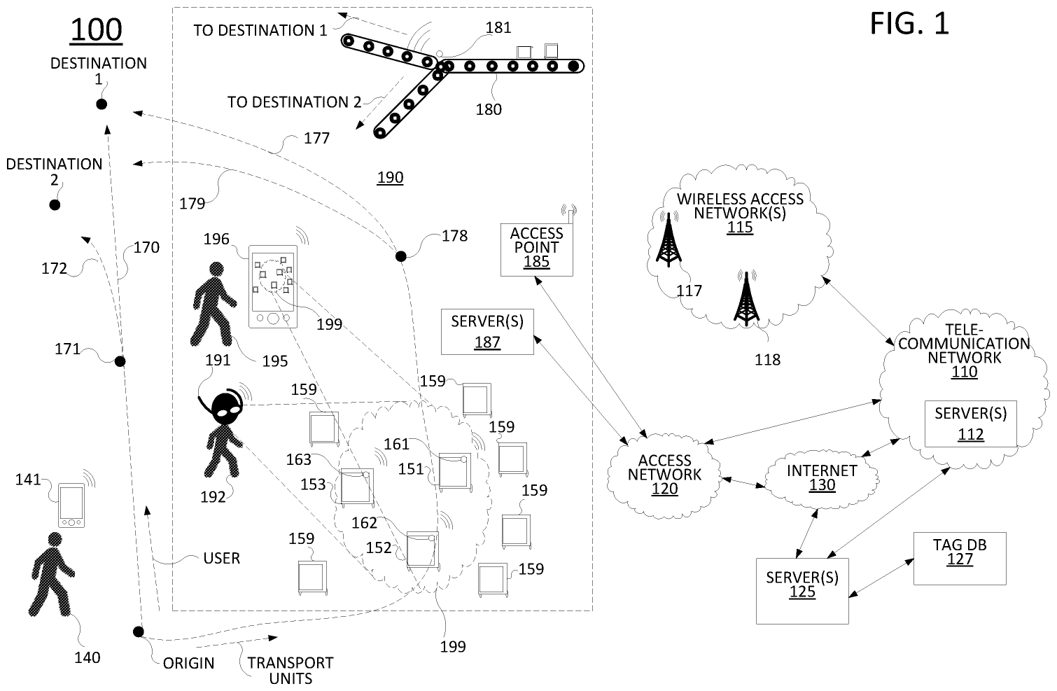

In one example, the instruction to the electronic identification tags may be in parallel to an instruction or notification to the carrier, e.g., via an airline system notifying the carrier of the transport units of a change in the user's travel itinerary. Thus, if one of the instructions/notifications fails, the other may still reach the AR device(s) of the carrier personnel to effect the initial diversion of the transport units. In addition, in an example where some of the electronic identification tags may comprise passive RFID tags, or do not possess independent WAN communication capabilities, a pod leader tag (and/or multiple tags with greater capabilities) may provide information regarding these other tags to the AR device. For example, the tag leader pod may provide information identifying itself and that the set of transport units is to be diverted. In addition, the tag leader pod may identify other electronic identification tags in the group. As such, the AR device may simply scan/detect these other electronic identification tags and based upon the tag identifiers alone, may match the associated transport units to the set of transport units that are to be diverted, and present the visual indication for any and all of the corresponding luggage items in the set that are viewable via the AR device. These and other aspects of the present disclosure are discussed in greater detail below in connection with the examples of FIGS. 1-4.

To aid in understanding the present disclosure, FIG. 1 illustrates an example system 100, related to the present disclosure. As shown in FIG. 1, the system 100 connects user device 141, AR endpoint devices 191 and 196 (e.g., user devices), server(s) 112, server(s) 125, access point 185, server(s) 187, electronic identification tags 161-163, and so forth with one another and with various other devices via a core network, e.g., a telecommunication network 110, a wireless access network 115 (e.g., a cellular network), and Internet 130. In one example, additional devices, such as node 181 may also be equipped for wired and/or wireless-based network communications and may be connected with various other devices, via the system 100, such as access point 185, servers 112, 125 and/or 187, electronic identification tags 161-163, user device 141, and so forth.

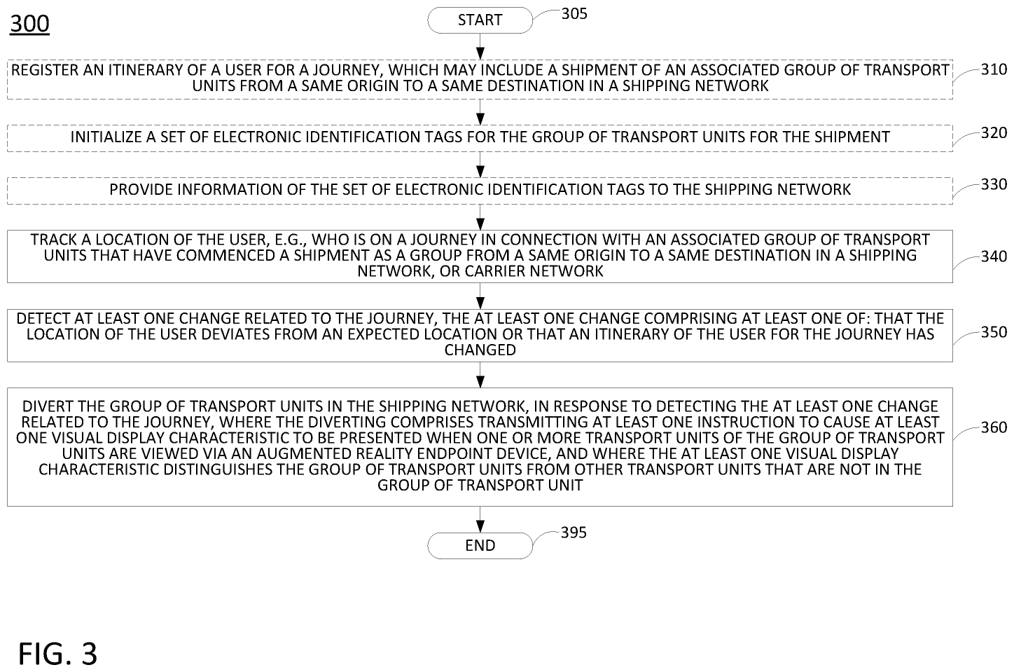

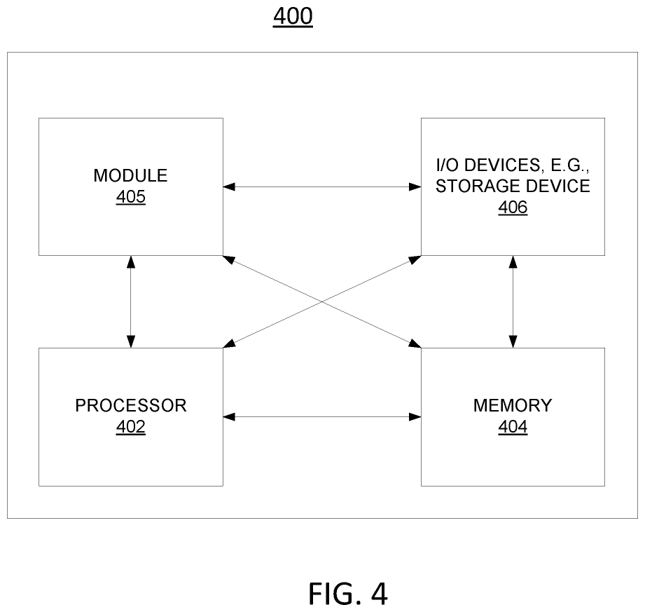

In one example, the server(s) 125 may each comprise a computing device or processing system, such as computing system 400 depicted in FIG. 4, and may be configured to perform one or more steps, functions, or operations in connection with examples of the present disclosure for diverting a group of transport units in a shipping network, via at least one instruction to cause at least one visual display characteristic to be presented when transport units of the group are viewed via an augmented reality endpoint device, in response to detecting at least one change related to a journey of a user associated with the group of transport units. For instance, an example method for diverting a group of transport units in a shipping network, via at least one instruction to cause at least one visual display characteristic to be presented when transport units of the group are viewed via an augmented reality endpoint device, in response to detecting at least one change related to a journey of a user associated with the group of transport units is illustrated in FIG. 3 and described below. In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device, or computing system, including one or more processors, or cores (e.g., as illustrated in FIG. 4 and discussed below) or multiple computing devices collectively configured to perform various steps, functions, and/or operations in accordance with the present disclosure.

In one example, server(s) 125 may comprise, or be coupled to or in communication with a tag database (DB) 127. For instance, the server(s) 112, or server(s) 125 in conjunction with tag database 127 may comprise a transport unit management system in accordance with the present disclosure. In one example, tag database 127 may represent one or more distributed file systems, e.g., a Hadoop® Distributed File System (HDFS™), or the like. Server(s) 125 may receive and store information regarding transport units, electronic identification tags, and users/user devices associated with such electronic identification tags in tag database 127.

In one example, the system 100 includes a telecommunication network 110. In one example, telecommunication network 110 may comprise a core network, a backbone network or transport network, such as an Internet Protocol (IP)/multi-protocol label switching (MPLS) network, where label switched routes (LSRs) can be assigned for routing Transmission Control Protocol (TCP)/IP packets, User Datagram Protocol (UDP)/IP packets, and other types of protocol data units (PDUs), and so forth. It should be noted that an IP network is broadly defined as a network that uses Internet Protocol to exchange data packets. However, it will be appreciated that the present disclosure is equally applicable to other types of data units and transport protocols, such as Frame Relay, and Asynchronous Transfer Mode (ATM). In one example, the telecommunication network 110 uses a network function virtualization infrastructure (NFVI), e.g., host devices or servers that are available as host devices to host virtual machines comprising virtual network functions (VNFs). In other words, at least a portion of the telecommunication network 110 may incorporate software-defined network (SDN) components.

As shown in FIG. 1, telecommunication network 110 may also include one or more servers 112. In one example, each of the server(s) 112 may comprise a computing device or processing system, such as computing system 400 depicted in FIG. 4 and may be configured to provide one or more functions in connection with examples of the present disclosure for diverting a group of transport units in a shipping network, via at least one instruction to cause at least one visual display characteristic to be presented when transport units of the group are viewed via an augmented reality endpoint device, in response to detecting at least one change related to a journey of a user associated with the group of transport units. For example, one or more of the server(s) 112 may be configured to perform one or more steps, functions, or operations in connection with the example method 300 described below. In one example, server(s) 112 may perform the same or similar functions as server(s) 125. For instance, telecommunication network 110 may provide a transport unit management system, e.g., as a service to one or more subscribers/customers, in addition to telephony services, data communication services, television services, etc. For ease of illustration, various additional elements of telecommunication network 110 are omitted from FIG. 1.

In one example, one or more wireless access networks 115 may each comprise a radio access network implementing such technologies as: global system for mobile communication (GSM), e.g., a base station subsystem (BSS), or IS-95, a universal mobile telecommunications system (UMTS) network employing wideband code division multiple access (WCDMA), or a CDMA3000 network, among others. In other words, wireless access network(s) 115 may each comprise an access network in accordance with any “second generation” (2G), “third generation” (3G), “fourth generation” (4G), Long Term Evolution (LTE), “fifth generation” (5G), or any other existing or yet to be developed future wireless/cellular network technology. While the present disclosure is not limited to any particular type of wireless access network, in the illustrative example, base stations 117 and 118 may each comprise a Node B, evolved Node B (eNodeB), or gNodeB (gNB), or any combination thereof providing a multi-generational/multi-technology-capable base station. In the present example, user device 141, electronic identification tags 161-163, AR devices 191 and 196, and so forth may be in communication with base stations 117 and 118, which provide connectivity between user device 141, electronic identification tags 161-163, AR devices 191 and 196, and other endpoint devices within the system 100, various network-based devices, such as server(s) 112, server(s) 125, and so forth. In one example, wireless access network(s) 115 may be operated by the same service provider that is operating telecommunication network 110, or one or more other service providers. For instance, telecommunication network 110 may comprise a cellular core network.

As illustrated in FIG. 1, user device 141 may comprise, for example, a cellular telephone, a smartphone, a tablet computing device, a laptop computer, a desktop computer, a wireless enabled wristwatch, or any other wireless and/or cellular-capable mobile telephony and computing devices (broadly, a “mobile device” or “mobile endpoint device”). In one example, user device 141 may be equipped for cellular and non-cellular wireless communication. For instance, user device 141 may include components which support peer-to-peer and/or short range wireless communications, e.g., IEEE 802.11 based communications (e.g., Wi-Fi, Wi-Fi Direct), IEEE 802.15 based communications (e.g., Bluetooth, Bluetooth Low Energy (BLE), and/or ZigBee communications), LTE Direct, Dedicated Short Range Communications (DSRC), e.g., in the 5.9 MHz band, or the like, a 5G device-to-device (D2D) sidelink, such as over a P5 interface, and so forth. For instance, user device 141 may include one or more radio frequency (RF) transceivers, e.g., for cellular communications and/or for non-cellular wireless communications. In one example, user device 141 may comprise a computing device or processing system, such as computing system 400 depicted in FIG. 4, and may be configured to perform one or more steps, functions, or operations in connection with examples of the present disclosure for diverting a group of transport units in a shipping network, via at least one instruction to cause at least one visual display characteristic to be presented when transport units of the group are viewed via an augmented reality endpoint device, in response to detecting at least one change related to a journey of a user associated with the group of transport units (such as illustrated in FIG. 3 and described below).

Similarly, transport units 151-153 may include electronic identification tags 161-163, which may include one or more radio frequency (RF) transceivers (as well as antenna(s), and/or other components) for cellular communications and/or for non-cellular wireless communications such as for IEEE 802.11 based communications, IEEE 802.15 based communications, and so forth. In one example, electronic identification tags 161-163 each may also include a module with one or more additional controllable components, such as an altimeter, a global positioning system (GPS) unit, an accelerometer, a gyroscope, a compass, a thermometer, a radiation sensor (e.g., an x-ray sensor), a microphone or acoustic sensor, and so forth. However, for ease of illustration, such components of electronic identification tags 161-163 may be omitted from FIG. 1. In addition, electronic identification tags 161-163 may each include a data storage unit (e.g., a solid state drive (SDD) and/or a non-volatile memory (NVM), or the like), for storing a tag information record.

In one example, electronic identification tags 161-163 may each comprise a computing device or processing system, such as computing system 400 depicted in FIG. 4, and may be configured to perform one or more steps, functions, or operations in connection with examples of the present disclosure for diverting a group of transport units in a shipping network, via at least one instruction to cause at least one visual display characteristic to be presented when transport units of the group are viewed via an augmented reality endpoint device, in response to detecting at least one change related to a journey of a user associated with the group of transport units (such as illustrated in FIG. 3 and described below).

In the present example, access point 185 may be associated with a transit location in a shipping network, or carrier network 190, e.g., a transshipment facility, a sorting facility, a storage facility (such as a warehouse), or the like, associated with a carrier that is handling the movement of transport units 151-153. For instance, access point 185 may be a wireless access point of a local network of the carrier network 190. As discussed further below, node 181 of automated sorting system 180 may also be in communication with access point 185 and may transmit and/or receive data from other devices in the system 100 via access point 185 (and/or via access network 120, Internet 130, wireless access network(s) 115, etc.). In one example, node 181 may have cellular or non-cellular wireless communication, or wired network communication capabilities (not shown). Carrier network 190 may also include server(s) 187, e.g., a shipment management system, which may track various transport units within the carrier network 190.

In an illustrative example, a user 140 having user device 141 may be commencing a trip from an origin to an intended destination (“destination 1”) with a set of transport units 151-153 (e.g., luggage items) being shipped separately via carrier network 190, where each of the transport units 151-153 includes an associated electronic identification tag 161-163, respectively. The user 140 may have a planned route indicated by path 170, which may correspond to a travel itinerary of the user 140. In addition, the set of transport units 151-153 may have an intended route 177 via the carrier network 190 to reach the same destination (“destination 1”). The set of transport units 151-153 may be tendered to the carrier network 190 before, after, or at the same time as user 140 commences traveling. In one example, user 140 may “activate” the electronic identification tags 161-163 for purposes of the shipment. For instance, the electronic identification tags 161-163 may be loaded with information regarding the origin, the intended destination (e.g., “destination 1”), and other information, such as the contents of the respective transport units 151-153, the contracted carrier(s), the expected shipment duration, any service level agreement (SLA) information, and so forth. The same or similar information may also be stored for the user 140 and each of the electronic identification tags 161-163 by server(s) 125 in tag database 127.

The particulars of the intended shipment of transport units 151-153 via the carrier network 190 may be pre-arranged as described above or in any available manner according to the capabilities of the user 140, user device 141, the carrier network 190, etc. However, in accordance with the present disclosure, the carrier network 190 may be provided with information of the electronic identification tags 161-163, e.g., including at least tag identifiers of each tag. In one example, the tag identifiers of each electronic identification tags 161-163 may be associated with transport units 151-153, e.g., by affixing shipping labels to each of the transport units 151-153, and associating the shipping labels with the respective tag identifiers, e.g., in a database of the carrier network 190. This may be accomplished by personnel of the carrier network 190, e.g., when picking up or accepting the transport units 151-153 for shipment at the origin, or by user 140, e.g., prior to tendering the transport units 151-153 to the carrier network 190. As such, the electronic identification tags 161-163 may store at least some of the same information that may be accessible within the carrier network 190 via the respective shipping labels, e.g., as stored by server(s) 187.

Continuing with the present example, user 140 may begin travelling from the origin to the destination 1 (e.g., represented by path 170) at the same time, before, or after the transport units 151-153 begin transiting the carrier network 190 toward destination 1, represented by path 177. The user 140 may, for example, travel to an airport, board a flight and travel to an airport near destination 1. According to a travel itinerary, user 140 may plan to ride a train from the airport to a city center, and walk to destination 1, e.g., a hotel. During the travel of user 140, the transport units 151-153 may be somewhere within the carrier network 190, e.g., at point 178. In the example of FIG. 1, during the travel of user 140, user 140 may have a change in plans. For instance, the user may have planned to go directly from the airport to the hotel (e.g., destination 1). However, the user 140 may receive a call that a meeting planned for an afternoon has been changed to a morning meeting. The user 140 may not have time to first go to the hotel and then travel to the meeting, which may be an hour drive away. In another example, the user 140 may experience a delay in traveling, such as a weather related flight delay, or the user 140 may miss an intended flight due to unforeseen traffic trying to reach the departure airport. Each of these scenarios, or similar scenarios (broadly, a change related to the journey) is represented in FIG. 1 by point 171, and may be detected in various ways. For instance, the user may make a specific change in the itinerary (e.g., via an airline app on the user device 141), an airline may change the itinerary (e.g., as part of a schedule change which may affect all passengers on one or more flights), the airline may detect that the user 140 did not board the scheduled flight, the user device 141 may track that it is not at the departure airport at the time the flight is scheduled to depart, the user device 141 may track that it is at a different city than the intended destination 1, and so forth (and similarly for other modes of transit, such as via an app of a rail carrier, a bus line, etc.).

In accordance with the present disclosure, when a change related to the journey of the user 140 is detected, this may also trigger a diverting of the set of transport units 151-153. In one example, the diverting may be effected by transmitting at least one instruction to cause at least one visual display characteristic to be presented when one or more transport units of the group of transport units 151-153 are viewed via an augmented reality (AR) endpoint device, where the at least one visual display characteristic distinguishes the group of transport units 151-153 from other transport units that are not in the group of transport units 151-153. For instance, the at least one instruction may be made by user device 141, a transportation provider system, such as an airline management system (not shown), server(s) 125, and so forth, and may be transmitted to one or more of the electronic identification tags 161-163, and alternatively or additionally, to the carrier network 190 (e.g., to server(s) 187).

To illustrate, a deviation of the user 140 from the intended path 170 may be detected by user device 141. This may be communicated to server(s) 125, or the location of user device 141 may be communicated to server(s) 125, which may detect that the user 140 is not on the intended path 170 (or is not proceeding on the intended path 170 at a planned pace). Similarly, an airline system may communicate a change in an itinerary of user 140 to server(s) 125. In such case, server(s) 125 may then notify the server(s) 187 via a transmission over one or more networks, such as telecommunication network 110, access network 120, Internet 130, etc., which may result in the altering of a value in a server record relating to the group of transport units, where the value may retrieved by an AR endpoint device to cause at least one visual display characteristic to be presented when one or more transport units of the group of transport units 151-153 are viewed via the augmented reality (AR) endpoint device. For instance, a user 192 with AR endpoint device 191 may view various transport units at a facility within the carrier network 190. In addition, the AR endpoint device 191 may scan/detect electronic identification tags 161-163, which may each provide information comprising at least a tag identifier. The AR endpoint device 191 may look-up the tag identifier(s) via server(s) 187, where the value(s) in the server record(s) may indicate to cause the at least one visual display characteristic to be presented when one or more transport units of the group of transport units 151-153 are viewed via the augmented reality (AR) endpoint device 191. For instance, as illustrated in FIG. 1, the AR endpoint device 191 may provide highlighting 199, e.g., of a same color, to distinguish the transport units 151-153 containing electronic identification tags 161-163 within the field of view from other transport units (e.g., transport units 159) that are not part of the set/group of transport units 151-153 of the user 140.

Alternatively, or in addition, in one particular example, server(s) 125 may send an instruction to one or more of the electronic identification tags 161-163, e.g., over one or more networks, such as telecommunication network 110 and wireless access network(s) 115 (e.g., via an LTE or 5G cellular connection), which may cause at least one visual display characteristic to be presented when one or more transport units of the group of transport units 151-153 are viewed via an augmented reality (AR) endpoint device, such as AR endpoint device 191. For instance, when the AR endpoint device 191 scan/detect electronic identification tags 161-163, one or more of the electronic identification tags 161-163 may provide information such as a respective tag identifier and a further indication of a visual display characteristic to be presented when one or more transport units of the group of transport units 151-153 are viewed via the AR endpoint device 191 (e.g., highlighting 199).

In still another example, the change related to the journey may be notified to the carrier network 190 (e.g., to server(s) 187) by the user device 141. For instance, the notification may be via an app of the carrier network 190 on the user device 141, or via an airline system notifying the carrier network 190, which may update the server record(s) of server(s) 187 for one or more of the electronic identification tags 161-163. FIG. 1 further illustrates a user 195, e.g., another personnel of the carrier network 190, having an AR endpoint device 196. For instance, AR endpoint device 191 may comprise AR glasses, or the like, while AR endpoint device 196 may comprise a smartphone that is capable of capturing images, e.g., via an outward facing camera, and presenting via a display screen the captured images that are altered to provide the visual display characteristic (e.g., highlighting 199). Notably, the visual display characteristic (e.g., highlighting 199) may indicate to users 192 and/or 195 not only that transport units 151-153 containing electronic identification tags 161-163 are to be diverted, but also that the transport units 151-153 are part of a set or group that should not be separated.

In one example, the visual display characteristic may further include an alternate destination of the transport units 151-153. For instance, in some cases, a specific alternate destination may not be determinable, in which case, the carrier network 190 may select to hold/halt the shipment of the transport units 151-153 at a current location or a next location at which temporary storage of the transport units 151-153 is possible. In another example, server(s) 125, and/or an app of the carrier network 190 may notify user 140 via user device 141 of the detection of the change related to the journey and request the user 140 to select whether the transport units 151-153 should continue to the original intended destination (destination 1), or to a user-selected alternate destination. In one example, server(s) 125 and/or the carrier network 190 may offer one or more recommended alternate destinations, from which user 140 may select one, or may select a different alternate destination that may be available. In any case, the user 140 may select “destination 2” as the alternate destination, which may be communicated from user device 141 to server(s) 125 and/or the carrier network 190. In one example, destination 2 may be a different hotel from one that the user 140 originally planned to stay, but which is part of the new/updated itinerary of user 140. Thus, destination 2 may initially be suggested as an alternate destination. In any case, in one example, the new/alternate destination (destination 2) may be presented via AR device 191 and/or AR device 196 (e.g., in addition to highlighting 199 or similar visual indication of the diversion of the set of transport units 151-153). As such, user 192 or user 195 may make sure to appropriately forward transport units 151-153 towards the alternate destination (e.g., toward destination 2 represented by path 179 branching off from point 178).

FIG. 1 further illustrates that in addition to providing a unique visual indication of the set of transport units 151-153 via AR endpoint devices, the same or similar instructions to electronic identification tags 161-163 and/or to the carrier network 190 may also be shared with automated equipment of the carrier network 190. For instance, the node 181 of automated sorting system 180 may scan/detect one or more of electronic identification tags 161-163, which may provide an indication to automated sorting system 180 of the new destination (e.g., destination 2). Thus, automated sorting system 180 may appropriately route the transport units 151-153 (which may involve loading onto a truck or other transportation vehicles, sending to a temporary storage area at a current location, and so forth). Alternatively, or in addition, automated sorting system 180 may access one or more server records of server(s) 187 for electronic identification tags 161-163, which may indicate the new destination (e.g., destination 2).

As noted above, in some instances, one or more of electronic identification tags 161-163 may comprise passive RFID tags, or may otherwise lack WAN communication capabilities. In such case, a pod leader tag that is scanned by AR endpoint device 191 or 196, node 181, etc. may respond with its own tag identifier and/or other information, as well as the tag identifiers of other tags in the set of electronic identification tags 161-163. Thus, AR endpoint device 191 or 196 may be informed to apply the same visual indication to all of the transport units 151-153 in the set when detected to be within the field of view. Similarly, automated sorting system 180 may also be informed to provide the same routing to all of the transport units 151-153 in the set.

The foregoing illustrates just one example of a system in which examples of the present disclosure for diverting a group of transport units in a shipping network, via at least one instruction to cause at least one visual display characteristic to be presented when transport units of the group are viewed via an augmented reality endpoint device, in response to detecting at least one change related to a journey of a user associated with the group of transport units may operate. In addition, the foregoing is described in connection with just one example travel scenario. However, it will be appreciated that transport unit monitoring, management, and diversion for various other travel scenarios through various other transit locations and in connection with various modes of transport or travel may be facilitated via the system 100.

In addition, electronic identification tags 161-163, server(s) 125, and so forth may also provide additional features. For instance, throughout the journey, in one example, one or more of electronic identification tags 161-163 may report their locations, e.g., detected via GPS units of the electronic identification tag 161-163, to server(s) 125. For instance, one or more of electronic identification tags 161-163 may report locations to servers(s) 125 via access point 185, base stations 117 and/or 118, and so forth, and over one or more networks such as access network 120, wireless access networks 115, Internet 130, telecommunication network 110, etc. In addition, electronic identification tags 161-163 may also perform local proximity sensing with one another such as via IEEE 802.15 communications, 802.11 communications (e.g., Wi-Fi Direct), etc., or other NFC and/or RFID-based scanning (e.g., per International Organization for Standardization (ISO)/International Electrical Commission (IEC) 18000, 18092, 18185, 21481, or the like), e.g., on an ongoing basis throughout the journey. In one example, when one or more of electronic identification tags 161-163 detect that one or more others of the electronic identification tags 161-163 may be outside of a designated range, an alert may be generated and transmitted, e.g., to user device 141 and/or to server(s) 125. Alternatively, or in addition, a notification may be sent to server(s) 187 of carrier network 190, e.g., such that personnel of carrier network 190 may confirm that the set of transport units 151-153 remains together, or if in fact one or more of the transport units 151-153 have become separated from the rest of the set. In this regard, the electronic identification tags 161-163 may also provide an alert to any scanning devices in the carrier network 190, e.g., AR endpoint devices 191 or 196, automated sorting system 180, etc. of the possible separation of the set of transport units 151-153. For instance, the indicator may cause AR endpoint devices 191 or 196 to further display an indicator over or near any of the transport units 151-153 associated with the electronic identification tags 161-163 visible via the AR endpoint devices 191 or 196 (e.g., another color of flashing indicator, text indicating that an item is apparently missing, etc.).

It should also be noted that the system 100 has been simplified. In other words, the system 100 may be implemented in a different form than that illustrated in FIG. 1. For example, the system 100 may be expanded to include additional networks, and additional network elements (not shown) such as wireless transceivers and/or base stations, border elements, routers, switches, policy servers, security devices, gateways, a network operations center (NOC), a content distribution network (CDN) and the like, without altering the scope of the present disclosure. In addition, system 100 may be altered to omit various elements, substitute elements for devices that perform the same or similar functions and/or combine elements that are illustrated as separate devices.

As just one example, one or more operations described above with respect to server(s) 125 may alternatively or additionally be performed by server(s) 112, and vice versa. In addition, although server(s) 112 and 125 are illustrated in the example of FIG. 1, in other, further, and different examples, the same or similar functions may be distributed among multiple other devices and/or systems within the telecommunication network 110, wireless access network(s) 115, and/or the system 100 in general that may collectively provide various services in connection with examples of the present disclosure for diverting a group of transport units in a shipping network, via at least one instruction to cause at least one visual display characteristic to be presented when transport units of the group are viewed via an augmented reality endpoint device, in response to detecting at least one change related to a journey of a user associated with the group of transport units. Additionally, devices that are illustrated and/or described as using one form of communication (such as a cellular or non-cellular wireless communications, wired communications, etc.) may alternatively or additionally utilize one or more other forms of communication. In still another example, there may be various different network-based transport unit management services with different servers and other infrastructure. Thus, these and other modifications are all contemplated within the scope of the present disclosure.

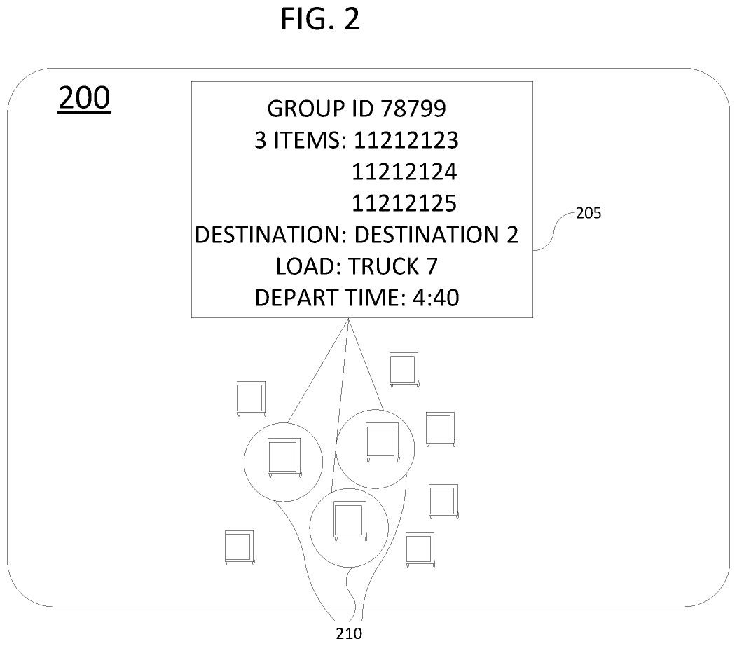

FIG. 2 illustrates an example display view 200, e.g., of an AR endpoint device. For instance, display view 200 may represent an example of what is visible to a user of an AR endpoint device when viewing transport units of a group of transport units having electronic identification tags in accordance with the present disclosure (e.g., transport units in group having a group ID of 78799). Notably, there are three transport units in the group, identified as items 11212123, 11212124, and 11212125. These may be numbers assigned by a carrier network for the transport units, which may be mapped to tag identifiers of the respective electronic identification tags of the three transport units. In addition to a visual display characteristic 210 (e.g., circling, highlighting, coloring, glowing, or the like) presented via the AR device and intersected with the field of view of the user, the AR device may also present in the display view 200 an information box 205, which may contain various information, such as the group ID and transport unit identifiers, a destination of the transport units in the set, information on where to load the transport units (e.g., truck 7), a departure time (e.g., 4:40 pm, when truck 7 may be scheduled to leave a transshipment facility), and so forth. It should be noted that display view 200 is just one example of how a set of transport units that is subject to diversion within a carrier network may be identified by a visual display characteristic presented via an AR device. For instance, other types of visual indications may be provided, e.g., depending upon the capabilities of the AR device, the configuration by an operator of the carrier network, the type of carrier (e.g., a rail carrier, versus an ocean liner service, etc.), the permissions of a user who shipped the set of transport units, and so on.

FIG. 3 illustrates a flowchart of an example method 300 for diverting a group of transport units in a shipping network, via at least one instruction to cause at least one visual display characteristic to be presented when transport units of the group are viewed via an augmented reality endpoint device, in response to detecting at least one change related to a journey of a user associated with the group of transport units. In one example, steps, functions and/or operations of the method 300 may be performed by a transport unit management system, a user device, or any one or more components thereof, or by electronic identification tag and/or any one or more components thereof in conjunction with one or more other components of the system 100, such as server(s) 125, server(s) 112, server(s) 187, electronic identification tags 161-163, elements of wireless access network 115, telecommunication network 110, and so forth.

In one example, the steps, functions, or operations of method 300 may be performed by a computing device or processing system, such as computing system 400 and/or hardware processor element 402 as described in connection with FIG. 4 below. For instance, the computing system 400 may represent any one or more components of the system 100 (e.g., server(s) 125, user device 141, etc.) that is/are configured to perform the steps, functions and/or operations of the method 300. Similarly, in one example, the steps, functions, or operations of the method 300 may be performed by a processing system comprising one or more computing devices collectively configured to perform various steps, functions, and/or operations of the method 300. For instance, multiple instances of the computing system 400 may collectively function as a processing system. For illustrative purposes, the method 300 is described in greater detail below in connection with an example performed by a processing system. The method 300 begins in step 305 and proceeds to one of optional steps 310-330, or to step 340.

At optional step 310, the processing system may register an itinerary of a user for a journey, which may include a shipment of an associated group of transport units from a same origin to a same destination in a shipping network. For instance, the user may arrange to travel, while separately shipping a set of transport units to the destination via a different carrier or carriers that will transport the user. For instance, the user may pre-ship the transport units via ground shipping in advance of the user flying to a destination.

At optional step 320, the processing system may initialize a set of electronic identification tags for the group of transport units for the shipment. For example, the electronic identification tags may be loaded with information regarding the origin and intended destination, the expected transit time, the identity of one or more carriers designated for the shipment of the transport units, the tag identifiers of each of the other tags in the set/group of tags, and so on. In one example, one or more of the electronic identification tags may include cellular communication capability and may report on a location throughout the shipment. In one example, one or more of the electronic identification tags may not have such capability, and/or may comprise passive RFID tags which may be managed by another electronic identification tag as a “group leader tag.”

At optional step 330, the processing system may provide information of the set of electronic identification tags to the shipping network (e.g., to one or more carriers, or carrier network(s)), such as the tag identifiers, the transport units to which the electronic identification tags are attached, the weights, dimensions, colors, or other characteristics of the respective transport units, and so on. For instance, in one example, this information may be provided to the carrier(s) in advance of tendering the transport units to the shipping network. However, in another example, information of the set of electronic identification tags may be obtained at the time of tendering to the shipping network (e.g., by scanning-in by a device of a carrier picking up or receiving the transport units from the user).

At step 340, the processing system tracks a location of the user, e.g., who is on a journey in connection with an associated group of transport units that have commenced a shipment as a group from a same origin to a same destination in a shipping network, or carrier network. For instance, the location of the user may be tracked via the user's mobile endpoint device (such as the mobile endpoint device reporting GPS location data), via user check-in along the journey (such as an airline carrier notifying of the user's check-in for a flight leg of the journey, a rental car office confirming the user has arrived for a scheduled pick-up, etc., and with permission of the user to share this information).

At step 350, the processing system detects at least one change related to the journey, the at least one change comprising at least one of: that the location of the user deviates from an expected location or that an itinerary of the user for the journey has changed. For instance, the location of the user tracked at step 340 may be compared to expected locations according to the itinerary. When the user is not at an expected location at an expected time or close to an expected time, or is determined to be at a different location, a deviation may be detected. In another example, the user may explicitly change the itinerary, where the change may be communicated from the user's mobile endpoint device. Alternatively, or in addition, the change in itinerary may be communicated from a computing system of a transport provider (e.g., an airline, train or bus line, travel agency, etc.). In one example, a transport provider may change the itinerary (e.g., as part of a schedule change which may affect all passengers on a flight, train, bus, etc.). Similarly, a transport provider may detect that the user did not board a scheduled flight, train, bus, etc. and per previous authorization of the user, may communicate to the shipping network that the user is not at an expected location.

At step 360, the processing system diverts the group of transport units in the shipping network, in response to detecting the at least one change related to the journey, wherein the diverting comprises transmitting at least one instruction to cause at least one visual display characteristic to be presented when one or more transport units of the group of transport units are viewed via an augmented reality endpoint device, where the at least one visual display characteristic distinguishes the group of transport units from other transport units that are not in the group of transport unit. In one example, the at least one instruction is transmitted to at least one electronic identification tag of a plurality of electronic identification tags of the group of transport units. For instance, the at least one electronic identification tag may provide the visual display characteristic to the augmented reality device, following a receipt of the at least one instruction, e.g., in response to a scan of the at least one electronic identification tag by the augmented reality device. In one example, the at least one electronic identification tag comprises a wireless transceiver with a wide area network communication capability to receive the at least one instruction.

In one example, the at least one electronic identification tag may comprise a group leader tag to manage the shipment of the group of transport units. For instance, the plurality of electronic identification tags comprises at least one passive radio frequency identification tag associated with at least one of the transport units in the group of transport units, where the at least one passive radio frequency identification tag is tracked by the group leader tag during the shipment. Thus, in one example, the group leader tag may provide information regarding the at least one passive radio frequency identification tag to the augmented reality device, e.g., to cause the at least one visual display characteristic to be presented when at least one transport unit of the group of transport units associated with the at least one passive radio frequency identification tag is viewed via the augmented reality endpoint device. In addition, in one example, the group leader tag may provide an alert to the augmented reality endpoint device when it is detected that the at least one passive radio frequency identification tag is outside of a radio frequency scanning range of the group leader tag, where the alert may be presented via the augmented reality endpoint device.

In one example, the at least one instruction may alternatively or additionally comprise and/or result in the altering of a value in a server record relating to the group of transport units, where the value is retrieved by the augmented reality endpoint device. In one example, step 360 may comprise halting a movement of the group of transport units at a next available storage location in the shipping network. In one example, step 360 may include transmitting a notification to the user of the detection of the at least one change related to the journey. In addition, in such an example, step 360 may further include obtaining a selected alternate destination from the user. For instance, the notification may include an offer of one or more alternate destinations, the one or more alternate destinations including the selected alternate destination. In one example, the offer may include costs, estimated time to reach alternate destination(s), allowed storage duration(s), costs for storage at alternate destination(s), and so on. In another example, the alternate destination may be automatically selected based upon at least one of: the location of the user or the itinerary of the user that has changed. For instance, the user may have initially selected a delivery location of a hotel room reserved by the user at hotel 1. However, the change in itinerary may indicate that the user has canceled the reservation at hotel 1 and is now booked at hotel 2. Thus, the processing system may initially assume that the user wishes to have the transport units similarly delivered to the user. In any case, in one example, the alternate destination may be confirmed by the user (or rejected and/or replaced by a different selection).

In one example, the at least one visual display characteristic comprises a same color highlighting being overlaid on the one or more transport units, wherein the same color distinguishes the group of transport units from other transport units that are not in the group of transport units. The at least one visual display characteristic may further comprise an outline, shading/shadowing, or the like, and may additionally include animation of such features, e.g., a moving border pattern, blinking, glowing, etc. In one example, the at least one visual display characteristic may further comprise a display of an alternate destination for the group of transport items (and/or other information, such as illustrated in FIG. 2, or the like).

Following step 360, the method 300 may proceed to step 395. At step 395, the method 300 ends.

It should be noted that the method 300 may be expanded to include additional steps, or may be modified to replace steps with different steps, to combine steps, to omit steps, to perform steps in a different order, and so forth. For instance, in one example the processing system may repeat one or more steps of the method 300, such as steps 310-340, or step 310-360 for additional trips. In one example, the method 300 may further include obtaining a user input dismissing the diversion, causing the diversion to be aborted, and/or reverting the transport to the original destination. In one example, the method 300 may include identifying possible alternative destinations for offering to the user, or for automatically selecting a best alternative destination according to one or more criteria, such as a closest carrier facility to a new destination of the user according to a change in itinerary, a different hotel as booked according to a change in the itinerary, and so forth. In one example, the method 300 may include tracking the movement of the transport units and electronic identification tags through the shipping network, determining that the transport units are not likely to reach the intended destination at a scheduled time, notifying the user, and obtaining an alternate destination, e.g., prior to step 360, which may involve diverting the group of transport units in the shipping network to the alternate destination by transmitting at least one instruction to cause at least one visual display characteristic to be presented when one or more transport units of the group of transport units are viewed via an augmented reality endpoint device.

In yet another example, aspects of the method 300 may alternatively be performed by a processing system of a shipping network, or carrier network. For instance, a carrier may offer a transport unit management service according to the present disclosure, e.g., in addition to the innate function of the carrier to transport items in the carrier network/shipping network. Thus, the management of the electronic identification tags, the tracking of the user location and/or changes in itinerary, and other aspects of the method 300 may alternatively or additionally be performed by components of the carrier network/shipping network (such as server(s) 187 of FIG. 1, or the like). Thus, these and other modifications are all contemplated within the scope of the present disclosure.

In addition, although not expressly specified above, one or more steps of the method 300 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 3 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the example embodiments of the present disclosure.

FIG. 4 depicts a high-level block diagram of a computing system 400 (e.g., a computing device or processing system) specifically programmed to perform the functions described herein. For example, any one or more components, devices, and/or systems illustrated in FIG. 1 or described in connection with FIGS. 1-3, may be implemented as the computing system 400. As depicted in FIG. 4, the computing system 400 comprises a hardware processor element 402 (e.g., comprising one or more hardware processors, which may include one or more microprocessor(s), one or more central processing units (CPUs), and/or the like, where the hardware processor element 402 may also represent one example of a “processing system” as referred to herein), a memory 404, (e.g., random access memory (RAM), read only memory (ROM), a disk drive, an optical drive, a magnetic drive, and/or a Universal Serial Bus (USB) drive), a module 405 for diverting a group of transport units in a shipping network, via at least one instruction to cause at least one visual display characteristic to be presented when transport units of the group are viewed via an augmented reality endpoint device, in response to detecting at least one change related to a journey of a user associated with the group of transport units, and various input/output devices 406, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one hardware processor element 402 is shown, the computing system 400 may employ a plurality of hardware processor elements. Furthermore, although only one computing device is shown in FIG. 4, if the method(s) as discussed above is implemented in a distributed or parallel manner for a particular illustrative example, e.g., the steps of the above method(s) or the entire method(s) are implemented across multiple or parallel computing devices, then the computing system 400 of FIG. 4 may represent each of those multiple or parallel computing devices. Furthermore, one or more hardware processor elements (e.g., hardware processor element 402) can be utilized in supporting a virtualized or shared computing environment. The virtualized computing environment may support one or more virtual machines which may be configured to operate as computers, servers, or other computing devices. In such virtualized virtual machines, hardware components such as hardware processors and computer-readable storage devices may be virtualized or logically represented. The hardware processor element 402 can also be configured or programmed to cause other devices to perform one or more operations as discussed above. In other words, the hardware processor element 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer-readable instructions pertaining to the method(s) discussed above can be used to configure one or more hardware processor elements to perform the steps, functions and/or operations of the above disclosed method(s). In one example, instructions and data for the present module 405 for diverting a group of transport units in a shipping network, via at least one instruction to cause at least one visual display characteristic to be presented when transport units of the group are viewed via an augmented reality endpoint device, in response to detecting at least one change related to a journey of a user associated with the group of transport units (e.g., a software program comprising computer-executable instructions) can be loaded into memory 404 and executed by hardware processor element 402 to implement the steps, functions or operations as discussed above in connection with the example method(s). Furthermore, when a hardware processor element executes instructions to perform operations, this could include the hardware processor element performing the operations directly and/or facilitating, directing, or cooperating with one or more additional hardware devices or components (e.g., a co-processor and the like) to perform the operations.

The processor (e.g., hardware processor element 402) executing the computer-readable instructions relating to the above described method(s) can be perceived as a programmed processor or a specialized processor. As such, the present module 405 for diverting a group of transport units in a shipping network, via at least one instruction to cause at least one visual display characteristic to be presented when transport units of the group are viewed via an augmented reality endpoint device, in response to detecting at least one change related to a journey of a user associated with the group of transport units (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium may comprise a physical device, a hardware device, or a device that is discernible by the touch. More specifically, the computer-readable storage device or medium may comprise any physical devices that provide the ability to store information such as instructions and/or data to be accessed by a processor or a computing device such as a computer or an application server.

While various examples have been described above, it should be understood that they have been presented by way of example only, and not limitation. Thus, the breadth and scope of a preferred example should not be limited by any of the above-described examples, but should be defined only in accordance with the following claims and their equivalents.

What is claimed is:

1. A method comprising:
tracking, by a processing system including at least one processor, a location of a user who is on a journey in connection with an associated group of transport units that have commenced a shipment as a group from a same origin to a same destination in a shipping network;
detecting, by the processing system, at least one change related to the journey, the at least one change comprising at least one of: that the location of the user deviates from an expected location or that an itinerary of the user for the journey has changed; and
diverting, by the processing system, the group of transport units in the shipping network, in response to the detecting the at least one change related to the journey, wherein the diverting comprises transmitting at least one instruction to cause at least one visual display characteristic to be presented when one or more transport units of the group of transport units are viewed via an augmented reality endpoint device, wherein the at least one visual display characteristic distinguishes the group of transport units from other transport units that are not in the group of transport units.

2. The method of claim 1, wherein the at least one instruction is transmitted to at least one electronic identification tag of a plurality of electronic identification tags of the group of transport units.

3. The method of claim 2, wherein the at least one electronic identification tag provides the visual display characteristic to the augmented reality endpoint device, following a receipt of the at least one instruction.

4. The method of claim 2, wherein the at least one electronic identification tag comprises a wireless transceiver with a wide area network communication capability to receive the at least one instruction.

5. The method of claim 2, wherein the at least one electronic identification tag comprises a group leader tag to manage the shipment of the group of transport units.

6. The method of claim 5, wherein the plurality of electronic identification tags comprises at least one passive radio frequency identification tag associated with at least one of the transport units in the group of transport units, wherein the at least one passive radio frequency identification tag is tracked by the group leader tag during the shipment.

7. The method of claim 5, wherein the group leader tag provides information regarding at least one passive radio frequency identification tag to the augmented reality endpoint device.

8. The method of claim 7, wherein the group leader tag provides an alert to the augmented reality endpoint device when it is detected that the at least one passive radio frequency identification tag is outside of a radio frequency scanning range of the group leader tag, wherein the alert is presented via the augmented reality endpoint device.

9. The method of claim 1, wherein the at least one instruction results in the altering of a value in a server record relating to the group of transport units, wherein the value is retrieved by the augmented reality endpoint device.

10. The method of claim 1, wherein the diverting comprises halting a movement of the group of transport units at a next storage location in the shipping network.

11. The method of claim 1, wherein the diverting comprises:
selecting an alternate destination for the group of transport units.

12. The method of claim 11, wherein the diverting further comprises:
transmitting a notification to a user endpoint device of the user of the detection of the at least one change related to the journey.

13. The method of claim 12, wherein the diverting further comprises:
obtaining the alternate destination from the user endpoint device of the user.

14. The method of claim 12, wherein the notification includes an offer of one or more alternate destinations, the one or more alternate destinations including the alternate destination that is selected.

15. The method of claim 11, wherein the alternate destination is selected based upon at least one of:
the location of the user; or
the itinerary of the user that has changed.

16. The method of claim 13, wherein the alternate destination is confirmed by the user.

17. The method of claim 1, wherein the at least one visual display characteristic comprises a same color highlighting being overlaid on the group of transport units, wherein the same color distinguishes the group of transport units from other transport units that are not in the group of transport units.

18. The method of claim 1, wherein the at least one visual display characteristic further comprises a display of an alternate destination for one or more transport units of the group of transport items.

19. A non-transitory computer-readable medium storing instructions which, when executed by a processing system including at least one processor, cause the processing system to perform operations, the operations comprising:
tracking a location of a user who is on a journey in connection with an associated group of transport units that have commenced a shipment as a group from a same origin to a same destination in a shipping network;
detecting at least one change related to the journey, the at least one change comprising at least one of: that the location of the user deviates from an expected location or that an itinerary of the user for the journey has changed; and
diverting the group of transport units in the shipping network, in response to the detecting the at least one change related to the journey, wherein the diverting comprises transmitting at least one instruction to cause at least one visual display characteristic to be presented when one or more transport units of the group of transport units are viewed via an augmented reality endpoint device, wherein the at least one visual display characteristic distinguishes the group of transport units from other transport units that are not in the group of transport units.

20. An apparatus comprising:
a processing system including at least one processor; and
a computer-readable medium storing instructions which, when executed by the processing system, cause the processing system to perform operations, the operations comprising:
tracking a location of a user who is on a journey in connection with an associated group of transport units that have commenced a shipment as a group from a same origin to a same destination in a shipping network;
detecting at least one change related to the journey, the at least one change comprising at least one of: that the location of the user deviates from an expected location or that an itinerary of the user for the journey has changed; and
diverting the group of transport units in the shipping network, in response to the detecting the at least one change related to the journey, wherein the diverting comprises transmitting at least one instruction to cause at least one visual display characteristic to be presented when one or more transport units of the group of transport units are viewed via an augmented reality endpoint device, wherein the at least one visual display characteristic distinguishes the group of transport units from other transport units that are not in the group of transport units.
